(19) United States
(12) Patent Application Publication
(10) Pub. No.: US 2024/0419458 A1
(43) Pub. Date: Dec. 19, 2024

(54) ALGORITHM RUNNING METHOD, APPARATUS AND DEVICE, AND STORAGE MEDIUM

(71) Applicant: BOE Technology Group Co., Ltd., Beijing (CN)

(72) Inventor: Zhen WANG, Beijing (CN)

(21) Appl. No.: 18/703,728

(22) PCT Filed: May 6, 2023
(86) PCT No.: PCT/CN2023/092570

§ 371 Date: Apr. 23, 2024

(30) Foreign Application Priority Data
May 31, 2022 (CN) 202210613711.0

(51) Int. Cl. G06F 9/445; G06F 9/50

(52) U.S. Cl. CPC G06F 9/44505; G06F 9/5027

(57) ABSTRACT

Provided in the embodiments of the present disclosure are an algorithm running method, apparatus and device, and a storage medium. The algorithm operation method comprises: acquiring grouping information of a plurality of groups of target algorithms; and running the plurality of groups of target algorithms on a plurality of data processing devices according to the grouping information of the plurality of groups of target algorithms, wherein target algorithms corresponding to the same group of grouping information run on the same data processing device.

### CROSS-REFERENCE TO RELATED APPLICATIONS

The present application is a U.S. National Phase Entry of International Application PCT/CN2023/092570 having an international filing date of May 6, 2023, which claims priority of Chinese patent application No. 202210613711.0, filed to the CNIPA on May 31, 2022 and entitled “Algorithm Running Method, Apparatus, Device and Storage Medium”, the contents of which should be construed as being incorporated herein by reference in their entireties.

### TECHNICAL FIELD

The embodiments of the disclosure relates to but is not limited to the technical field of artificial intelligence, in particular to an algorithm, an apparatus, and a device for running a method and a storage medium.

### BACKGROUND

In recent years, with the development of Artificial Intelligence, more and more AI (Artificial Intelligence) algorithms have been developed and applied to various industries. For example, computer vision based on deep learning is widely used in various fields.

### SUMMARY

The following is a summary of subject matter described herein in detail. This summary is not intended to limit the protection scope of claims.

In a first aspect, the embodiment of the present disclosure provides an algorithm running method, including:
acquiring grouping information of a plurality of groups of target algorithms;
running a plurality of groups of target algorithms on a plurality of data processing devices according to the grouping information of the plurality of groups of target algorithms; wherein target algorithms corresponding to a same group of grouping information are run on a same data processing device.

In an exemplary embodiment, before acquiring the grouping information of the plurality of groups of target algorithms, the method further includes:
acquiring available resources of the plurality of data processing devices and resource consumption required for deploying any one of the target algorithms; and
grouping the plurality of target algorithms in units of the data processing devices according to the available resources and the resource consumption; a same target algorithm and an algorithm model corresponding to the algorithm being divided into a same group of data processing devices, wherein the same group of data processing devices corresponds to at least one target algorithm and an algorithm model corresponding to the at least one target algorithm.

In an exemplary embodiment, any group of grouping information includes at least one piece of target algorithm information and algorithm model information corresponding to the at least one piece of target algorithm information.

In an exemplary embodiment, grouping the plurality of target algorithms in units of the data processing devices according to the available resources and the resource consumption includes:
taking a group of algorithm models most commonly used for the plurality of target algorithms as a current algorithm model group, and selecting a group of data processing devices as the current data processing devices;
adding the current algorithm model group into the current data processing devices;
determining whether available resources of the current data processing devices can accommodate and deploy all target algorithms corresponding to the current algorithm model group according to the available resources of the current data processing devices and resource consumption for deploying all the target algorithms corresponding to the current algorithm model group; and
adding all the target algorithms corresponding to the current algorithm model group into the current data processing devices when it is determined that the current data processing devices can accommodate and deploy all the target algorithms corresponding to the current algorithm model group; taking a group of algorithm models most commonly used for a plurality of ungrouped target algorithms as the current algorithm model group, and then adding the current algorithm model group into the current data processing devices.

In the exemplary embodiment, when it is determined that the current data processing devices cannot accommodate and deploy all the target algorithms corresponding to the current algorithm model group, the method further includes:
adding target algorithms corresponding to the current algorithm model group which can be accommodated by the current data processing devices into the current data processing devices, adding a new group of data processing devices as the current data processing devices, adding algorithm models in a previous group of data processing devices into the current data processing devices, and adding the ungrouped target algorithms corresponding to the current algorithm model group into the current data processing devices; taking the group of algorithm models most commonly used for the plurality of ungrouped target algorithms as the current algorithm model group, and then adding the current algorithm model group into the current data processing devices.

In an exemplary embodiment, acquiring the grouping information of the plurality of groups of target algorithms includes: acquiring an algorithm deployment table including the grouping information of the plurality of groups of target algorithms and resource configuration information of the target algorithms, the grouping information including a plurality of algorithm grouping identifiers;
running the plurality of groups of target algorithms on the plurality of data processing devices according to the grouping information of the plurality of groups of target algorithms includes:
generating a plurality of first configuration files according to the plurality of algorithm grouping identifiers, writing start commands of all target algorithms corresponding to a same algorithm grouping identifier into a first configuration file corresponding to the algorithm grouping identifier;
configuring a data processing device for the plurality of first configuration files respectively according to resource configuration information of a plurality of groups of target algorithms corresponding to the first configuration files;
starting micro service containers in corresponding data processing devices according to the first configuration files, and starting model managers in the micro service containers;
controlling the model managers to load the algorithm models corresponding to the group of target algorithms; and
running corresponding target algorithms in corresponding micro service containers; wherein algorithms and model managers corresponding to a same algorithm grouping identifier are started in a same data processing device.

In the exemplary embodiment, after running the corresponding target algorithms in the corresponding micro service containers, the method further includes outputting and saving running results of the algorithms.

In an exemplary embodiment, running the corresponding target algorithms in the corresponding micro service containers includes running the corresponding target algorithms in the corresponding micro service containers and calling algorithm models required by the target algorithms.

In an exemplary embodiment, the algorithm deployment table further includes algorithm code addresses and algorithm running paths;
before starting the corresponding target algorithms in the corresponding micro service containers, the method further includes: acquiring codes of the target algorithms according to the algorithm code addresses; and
the starting the corresponding target algorithms in the corresponding micro service containers includes: running codes of the corresponding target algorithms in the corresponding micro servers according to the algorithm running paths.

In an exemplary embodiment, the algorithm deployment table further includes a test video stream address, an algorithm name and a feedback test output address;
after acquiring the algorithm deployment table, the method further includes: acquiring a video source file according to the test video stream address, pushing the video source file used for testing the target algorithms into a video stream using a preset push stream mirror, generating a pull stream address, and updating a first configuration file corresponding to the target algorithms by using the pull stream address; wherein the video stream address and the pull stream address include a video name, and the video name has a corresponding relationship with a corresponding algorithm name;
after running the corresponding target algorithms in the corresponding micro service containers, the method further includes: traversing the target algorithms of the video stream to be tested according to the algorithm deployment table, starting a test platform, starting the target algorithms of the video stream to be tested for playing test according to the corresponding video stream address, waiting for a preset time, collecting test reports fed back by a plurality of target algorithms, and sending information on failure in passing the test to an abnormal information feedback platform through the feedback test output address.

In an exemplary embodiment, the algorithm deployment table further includes algorithm model information;
before acquiring the grouping information of the plurality of groups of target algorithms, the method further includes: converting original algorithm models in a model repository into open neural network exchange format, converting the open neural network exchange format to obtain TensorRT models, and saving the TensorRT models into the model repository; merging a part of network layers in the original algorithm models in a process of converting into the TensorRT models; and
controlling the model managers to load the algorithm models corresponding to the group of target algorithms includes: acquiring the algorithm model information corresponding to the target algorithms, and controlling the model managers to load the TensorRT models corresponding to the algorithm model information from the model repository.

In an exemplary embodiment, after running the corresponding target algorithms in the corresponding micro service containers, the method further includes: testing all the target algorithms according to the service deployment table, and outputting and saving test results.

In an exemplary embodiment, before acquiring grouping information of the plurality of groups of target algorithms, the method further includes: triggering periodic deployment; and after running the plurality of groups of target algorithms on the plurality of data processing devices according to the grouping information of the plurality of groups of target algorithms, the method further includes triggering periodic detection.

In a second aspect, an embodiment of the present disclosure further provides an algorithm running apparatus, including: an acquisition module and a running module;
the acquisition module is configured to acquire grouping information of a plurality of groups of target algorithms;
the running module is configured to run the plurality of groups of target algorithms on a plurality of data processing devices according to the grouping information of the plurality of groups of target algorithms; wherein target algorithms corresponding to a same group of grouping information are run on a same data processing device.

In a third aspect, an embodiment of the present disclosure further provides an algorithm running device, including a memory, a processor, and a computer program stored on the memory and runnable on the processor, to perform:
acquiring grouping information of a plurality of groups of target algorithms;
running the plurality of groups of target algorithms on a plurality of data processing devices according to the grouping information of the plurality of groups of target algorithms; wherein, target algorithms corresponding to a same group of grouping information are run on a same data processing device.

In a fourth aspect, an embodiment of the present disclosure further provides a non-transitory computer-readable storage medium, configured to store computer program instructions, wherein when the computer program instructions are executed, the algorithm running method according to any one of the above embodiments can be implemented.

Other aspects of the present disclosure may be comprehended after the drawings and the detailed descriptions are read and understood.

### BRIEF DESCRIPTION OF DRAWINGS

Accompanying drawings are used to provide an understanding of technical solutions of the embodiments of the present disclosure, form a part of the specification, and are used to explain, together with the embodiments of the present disclosure, the technical solutions of the embodiments of the present disclosure but are not intended to form limitations on the technical solutions of the present disclosure.

FIG. 1 is a flowchart of an algorithm running method according to an embodiment of the present disclosure.

FIG. 2a is a schematic diagram of a logical structure of an automated deployment module according to an exemplary embodiment of the present disclosure.

FIG. 2b is a schematic diagram of a logical architecture for AI algorithm automated detection according to an exemplary embodiment of the present disclosure.

FIG. 2c is a schematic diagram of a Jenkins framework structure according to an exemplary embodiment of the present disclosure.

FIG. 3 is a flowchart of running status check for AI platform according to an exemplary embodiment of the present disclosure.

FIG. 4 is a flowchart of running status check for AI algorithm according to an exemplary embodiment of the present disclosure.

FIG. 5 is a schematic diagram of a logical structure of an algorithm metric test according to an exemplary embodiment of the present disclosure.

FIG. 6a is a schematic diagram of a logical framework of video source processing according to an exemplary embodiment of the present disclosure.

FIG. 6b is a schematic diagram of a logical framework of video source processing according to an exemplary embodiment of the present disclosure.

FIG. 7 is a schematic diagram of an algorithm running apparatus module according to an embodiment of the present disclosure.

FIG. 8 is a schematic diagram of an algorithm running device module according to an embodiment of the present disclosure.

### DETAILED DESCRIPTION

Embodiments of the present disclosure will be described in detail hereinafter with reference to the drawings. It is to be noted that the embodiments in the present disclosure and features in the embodiments may be randomly combined with each other if there is no conflict.

Unless otherwise defined, technical terms or scientific terms used in the embodiments of the present disclosure should have usual meanings understood by those of ordinary skills in the art to which the present disclosure belongs. “First”, “second”, and similar terms used in the embodiments of the present disclosure do not represent any order, quantity, or importance, but are only used for distinguishing different components. “Include”, “contain”, or a similar word means that an element or object appearing before the word covers an element or object listed after the word and equivalent thereof and does not exclude other elements or objects.

In the specification, unless otherwise specified and defined, terms “mounting”, “mutual connection”, and “connection” should be understood in a broad sense. For example, a connection may be a fixed connection, or may be a detachable connection, or an integral connection; it may be a mechanical connection, or may be an electrical connection; it may be a direct connection, or may be an indirect connection through middleware, or may be an internal connection between two elements. Those of ordinary skills in the art may understand actual meanings of the aforementioned terms in the present disclosure according to actual situations.

After the algorithm research and development is completed, there will be many problems in a process of engineering implementation of the algorithm, such as adaptation of algorithm to server environment, slow model reasoning speed, high resource occupation and cumbersome test process after algorithm deployment, which will lead to a low engineering efficiency and a high cost of AI algorithm.

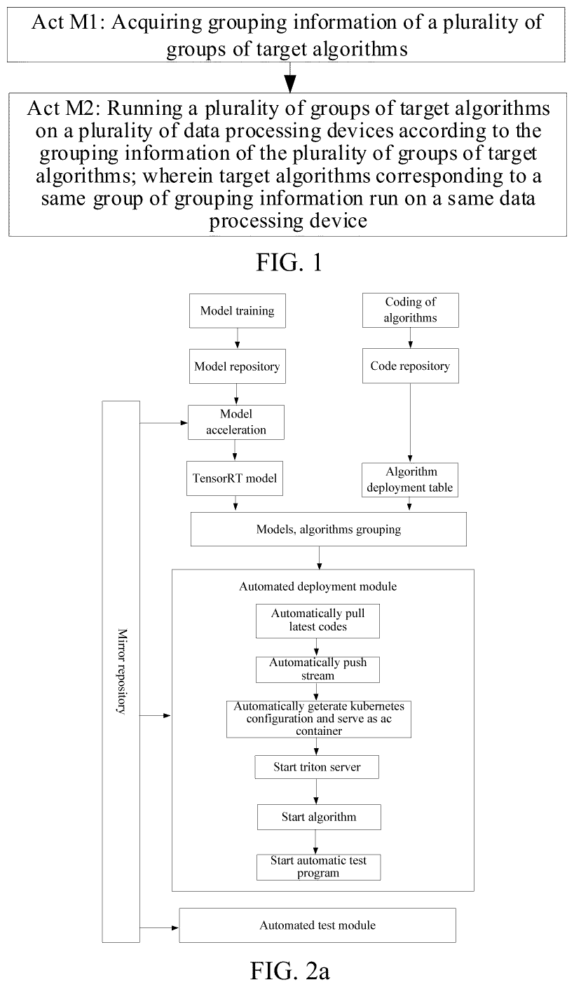

An embodiment of the present disclosure provides an algorithm running method. As shown in FIG. 1, the algorithm running method may include the following acts:
Act M1: acquiring grouping information of a plurality of groups of target algorithms;
Act M2: running the plurality of groups of target algorithms on a plurality of data processing devices according to the grouping information of the plurality of groups of target algorithms; wherein target algorithms corresponding to a same group of grouping information run on a same data processing device.

According to the algorithm running method provided by the embodiment of the disclosure, the plurality of groups of target algorithms are run on the plurality of data processing devices according to the grouping information of the plurality of groups of target algorithms, and the target algorithms corresponding to the same group of grouping information run on the same data processing device. The method provided by the embodiment of the disclosure can overcome the problems of high source occupation during algorithm deployment and operation, thereby enabling the AI algorithm to have high engineering efficiency and low cost.

In an exemplary embodiment, any group of grouping information includes at least one piece of target algorithm information and algorithm model information corresponding to the at least one piece of target algorithm information. In an embodiment of the present disclosure, the plurality of target algorithms running on the same data processing device are a same group of target algorithms, and algorithm models corresponding to the plurality of target algorithms and the corresponding plurality of target algorithms are all run on a same data processing device. Herein, the plurality of target algorithms divided into a same group and the corresponding plurality of model algorithms can usually be divided according to the actual service needs, for example, under a restricted area monitoring and warning service process, there can be a human body recognition algorithm and a vehicle recognition algorithm, then an algorithm model corresponding to the human body recognition algorithm includes a human body detection algorithm model that has undergone deep learning/training, and an algorithm model corresponding to the vehicle recognition algorithm includes a vehicle detection algorithm model that has undergone deep learning/training. In an actual process of running an algorithm, the human body recognition algorithm is taken as an example for illustration: in the process of running the algorithm, it is necessary to detect whether a human body enters a restricted area, then the human body recognition algorithm calls the human body detection algorithm model to detect whether the human body enters the restricted area, and outputs warning information when the human body enters the restricted area.

In an embodiment of the present disclosure, in a plurality of target algorithms and a plurality of algorithm models running on a same data processing device, a quantity of target algorithms and a quantity of algorithm models may not be in one-to-one correspondence, but a plurality of model algorithms running on the same data processing device are called when at least one of the plurality of target algorithms runs. For example, a group of target algorithms may include ten target algorithms and five algorithm models, in which the five algorithm models are all used in running processes of three target algorithms, and only one or two of the target algorithms are called in running processes of other two target algorithms.

In an embodiment of the present disclosure, a plurality of target algorithms in a same group of target algorithms and algorithm models corresponding to the plurality of target algorithms run on a same data processing device, which can save resources. In a case that the data processing device has a problem or a platform supporting the data processing device has faults, the plurality of target algorithms can be run on other platforms without faults and data processing devices without problems, which improves disaster tolerance of algorithm running.

In an exemplary implementation, before the act M1, the algorithm running method may include the following acts S1 to S2.
Act S1: acquiring available resources of a plurality of data processing devices and resource consumption required for deploying any target algorithm;
Act S2: grouping a plurality of target algorithms with data processing device as a unit according to available resources and resource consumption; wherein the same target algorithm and the algorithm model corresponding to the algorithm are divided into a same group of data processing devices, and the same group of data processing devices correspond to at least one target algorithm and an algorithm model corresponding to the at least one target algorithm.

In an embodiment of the present disclosure, the acts S1 to S2 can be executed manually or automatically by a script program or an algorithm.

In an embodiment of the present disclosure, an operation method of the above acts M1-M2 can be applied to an algorithm deployment process.

In an embodiment of the present disclosure, the data processing device may be a GPU card (or GPU processor), but is not limited to a GUP card (or GPU processor). For example, the data processing device may be a CPU processor, the data processing device may be arranged in a target apparatus, and the target apparatus may be a cloud server, but is not limited to a cloud server, for example, the target apparatus may be any one server in a server cluster.

In an embodiment of the present disclosure, the resource consumption of the target algorithm may be a resource of the data processing device consumed for running the target algorithm. For example, the resource consumption of the target algorithm can be space of GPU and/or CPU occupied during running the target algorithm. For example, if a target algorithm needs to occupy 50 MB of GPU during the running, the resource consumption of the target algorithm includes 50 MB of GPU space.

In an exemplary embodiment, in act S2, a plurality of target algorithms are grouped in units of data processing devices according to available resources and resource consumption, which may include acts S21-S23:
Act S21: taking a group of algorithm models most commonly used for the plurality of target algorithms as a current algorithm model group, and selecting a group of data processing devices as current data processing devices;
Act S22: adding the current algorithm model group into the current data processing devices;
Act S23: according to available resources of the current data processing devices and resource consumption of all target algorithms corresponding to deployment of the current algorithm model group, determining whether the available resources of the current data processing devices can accommodate and deploy all the target algorithms corresponding to the current algorithm model group; adding all the target algorithms corresponding to the current algorithm model group into the current data processing devices when it is determined that the current data processing devices can accommodate and deploy all the target algorithms corresponding to the current algorithm model group; taking a group of algorithm models most commonly used for a plurality of ungrouped target algorithms as the current algorithm model, and then adding the current algorithm model group into the current data processing devices.

In an exemplary embodiment, in act S23, when it is determined whether the current data processing devices cannot accommodate and deploy all target algorithms corresponding to the current algorithm model group, the method may further include:
adding target algorithms corresponding to the current algorithm model group which can be accommodated by the current data processing devices into the current data processing devices, adding a new group of data processing devices as the current data processing devices, adding algorithm models in a previous group of data processing devices into the current data processing devices, and adding ungrouped target algorithms corresponding to the current algorithm model group into the current data processing devices; taking a group of algorithm models most commonly used for a plurality of ungrouped target algorithms as the current algorithm model group, and then adding the current algorithm model group into the current data processing devices.

In an exemplary embodiment, Act M1 may include: acquiring an algorithm deployment table including grouping information of a plurality of groups of target algorithms and resource configuration information of the target algorithms, the grouping information including a plurality of pieces of algorithm identification information.

In an exemplary embodiment, the algorithm deployment table may be a CSV file, which may be filled out by an algorithm developer or generated according to information filled out by a user.

Act M2 may include:
Act M21: generating a plurality of first configuration files according to a plurality of algorithm grouping identifiers, writing start commands of all target algorithms corresponding to a same algorithm grouping identifier into a first configuration file corresponding to the group of algorithm identifiers.
Act M22: according to resource configuration information of a plurality of groups of target algorithms corresponding to a first configuration file, configuring a data processing device for a plurality of first configuration files, respectively;
Act M23: starting a micro service container in a corresponding data processing device according to the first configuration file, and starting a model manager in the micro service container.

In an embodiment of the present disclosure, the first configuration file may be a kubernetes configuration file, the micro service container may be a kubernetes container, and the model manager may be a triton server.
Act M2: controlling a model manager to load the algorithm models corresponding to the target algorithms.
Act M25: running a corresponding target algorithm in a corresponding micro service container; starting the algorithms and the model manager corresponding to a same group of algorithm groupings identifiers in a same data processing device.

In an exemplary embodiment, after running the corresponding target algorithm in the corresponding micro service container, the method further includes: outputting and saving a running result of the algorithm.

In an exemplary embodiment, running the corresponding target algorithm in the corresponding micro service container includes running the corresponding target algorithm in the corresponding micro service container and calling an algorithm model required by the target algorithm.

In an exemplary embodiment, the output running result of the algorithm can be fed back to a JIRA platform through a JIRA interface, and a relevant person in charge can acquire the corresponding running result by logging in to the JIRA platform, thereby realizing closed-loop management of the algorithm deployment and improving an efficiency of the algorithm deployment.

In an embodiment of the present disclosure, the algorithms and the model manager corresponding to a same group of the algorithm grouping identifiers are started in a same data processing device, so that the algorithms and the model manager of the same group only need a resource of one GUP to be run, do not need other environmental requirements, and can be run on any GPU in a same cluster, thereby having higher disaster tolerance.

In an exemplary embodiment, the algorithm deployment table may further include an algorithm code address and an algorithm run path.

Before starting the corresponding target algorithm in the corresponding micro service container in the execution of act M25, the method may further include: acquiring codes of the target algorithm according to the algorithm code address.

In act M25, starting the corresponding target algorithm in the corresponding micro service container may include: running codes of the corresponding target algorithm in a corresponding micro server according to the algorithm running path.

In an exemplary embodiment, the algorithm deployment table further includes a test video stream address, an algorithm name and a feedback test output address.

After acquiring the algorithm deployment table in the execution of act M1, the method may further include: acquiring a video source file according to the test video stream address, pushing the video source file used for testing the target algorithm into a video stream using a preset push stream mirror, generating a pull stream address, and updating the first configuration file corresponding to the target algorithm by using the pull stream address; the video stream address and the pull stream address including a video name, and the video name having a corresponding relationship with a corresponding algorithm name.

In act M25, after running the corresponding target algorithm in the corresponding micro service container, the method may further include: traversing the target algorithm of the video stream to be tested according to the algorithm deployment table, starting the test platform, starting the target algorithm of the video stream to be tested for playing test according to the corresponding video stream address, waiting for a preset time, collecting test reports fed back by a plurality of target algorithms, and sending information about failure in passing the test to an abnormal information feedback platform through the feedback test output address.

In an exemplary embodiment, the video name having the corresponding relationship with the corresponding algorithm name may include the video name being the same as the corresponding algorithm name, or other corresponding relationship.

In an exemplary embodiment, the abnormal information feedback platform may be a JIRA platform and the feedback test output address may be a jiraID corresponding to the target algorithm.

In an exemplary embodiment, the algorithm deployment table may further include algorithm model information.

Before acquiring the grouping information of the plurality of groups of target algorithms in the execution of act M1, the method further includes: converting an original algorithm model in a model repository into an open neural network exchange format, converting the open neural network exchange format to obtain a TensorRT model, and saving the TensorRT model into the model repository; merging a part of a network layer in the original algorithm model in a process of converting into the TensorRT model;

In act M24, the controlling the model manager to load the algorithm model corresponding to the target algorithm may include: acquiring algorithm model information corresponding to the target algorithm, and controlling the model manager to load a TensorRT model corresponding to the algorithm model information from the model repository.

In an embodiment of the present disclosure, the original algorithm model may be a pytorch model. In an embodiment of the present disclosure, an original pytorch algorithm model in the model repository is converted into the open neural network exchange format and the open neural network exchange format is converted to obtain the TensorRT model, which can improve a reasoning speed of the model.

In an exemplary embodiment, after running the corresponding target algorithm in the corresponding micro service container in act M25, the method may further include testing all target algorithms according to the service deployment table, and outputting and saving test results. In an exemplary embodiment, the output test results can be fed back to the JIRA platform through the JIRA interface, and a relevant person in charge can acquire the corresponding test results by logging in to the JIRA platform, thereby realizing the closed-loop management of the algorithm deployment and improving the efficiency of the algorithm deployment.

In an exemplary embodiment, before execution of act M1, the method may further include triggering periodic deployment. In an embodiment of the present disclosure, in a case of deployment of a large-scale algorithm, process control can be carried out through an automated deployment script during the above deployment process of the algorithm. There are two automated deployment modes: one is that a user logs in to a deployment server for manual execution, and the other is to periodically trigger an automated deployment platform by Jenkins to automatically deploy a target algorithm to a target apparatus.

In an exemplary embodiment, after execution of act M2, the method may further include triggering periodic detection.

In an exemplary embodiment, a target algorithm deployed on a target apparatus can be automatically detected by periodically triggering an automated detection platform (hereinafter referred to as the detection platform) by Jenkins, which can improve real-time performance and detection efficiency of algorithm detection.

In an embodiment of the present disclosure, automated detection and automated deployment are periodically triggered by Jenkins, and test results and running results after the algorithm deployment are fed back to the JIRA platform through the JIRA interface. A user can acquire corresponding test results or deployment running results by logging in to the JIRA platform, thereby forming a closed-loop development, improving the development efficiency, so that an engineering implementation efficiency of the algorithm is improved and an engineering implementation cost of the algorithm is reduced.

In an embodiment of the present disclosure, the periodically triggering the automated detection can be controlled by a test script.

In an embodiment of the present disclosure, the target algorithm may be an AI algorithm. The following is a detailed description of algorithm deployment: in an embodiment of the present disclosure, after the target algorithm model is trained and after algorithm coding, the next act faced by the AI algorithm is deployment. Model deployment is different from model training. When AI algorithms are commercialized, they should not only keep various performance metrics of algorithms, but also be fast enough (a minimum requirement must be real-time processing). According to different service scenarios for the algorithms, most of the algorithms are deployed on cloud servers. A main challenge is concurrent service capability, and the main metrics are throughput and latency.

TensorRT is a software stack by NVIDIA for accelerating deep learning model, which provides many methods for model optimization, including deep neural network layer fusion, automatic selection of best kernel implementation according to a target GPU, memory reuse and int8 type quantization.

Triton inference server is an open source software stack for servicing AI reasoning, which can manage models of different deep learning frameworks in a unified way, such as TensorFlow, PyTorch, TensorRT, ONNX and Triton inference server, which can also support concurrency of model reasoning.

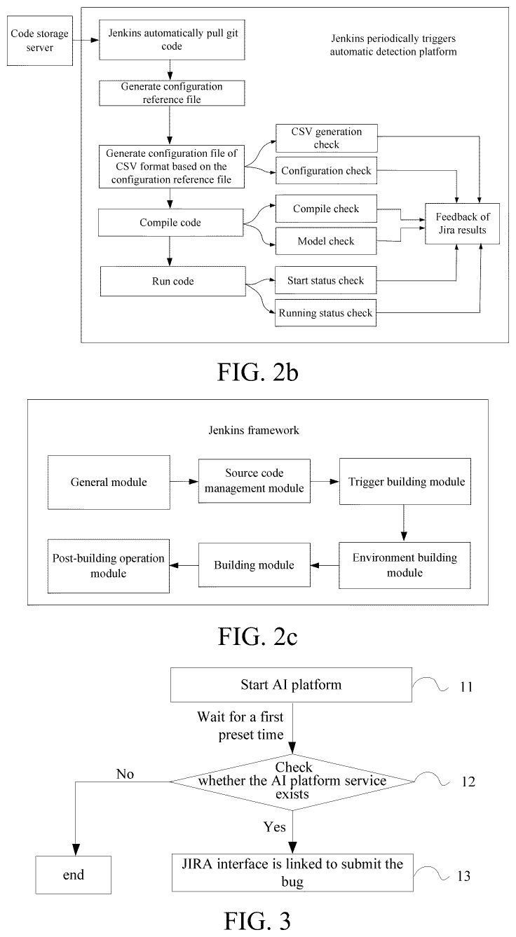

As shown in FIG. 2a, it is a schematic diagram of a logical structure of an automated deployment module for deploying a target algorithm. The automated deployment modules can include the following modules:

### I, Resource Repositories: Including a Model Repository, an Algorithm Code Repository and a Mirror Repository

Model repository: configured to store weight files of each functional model after training. When AI algorithm is deployed, model weights are uniformly pulled from the model repository according to models required by services.

Algorithm code repository: the algorithm code repository is configured to store policy codes of services and the corresponding algorithm codes. When AI algorithm is deployed, the algorithm codes are uniformly pulled from the algorithm code repository according to algorithm services.

Mirror repository: it may be a Docker mirror repository, which is configured to store docker mirrors used in a deployment process of AI algorithm. During the deployment, a kubernetes container is started directly with a fixed version of mirror.

### II, Model Acceleration Module

The embodiment of the present disclosure employs a model acceleration technology stack of pytorch->onnx->TensorRT. Firstly, the original model is converted into onnx (Open Neural Network Exchange) format, and then into a TensorRT model. In the process of converting into rge TensorRT model, some network layers of the original model will be merged, and special optimization will be made for NVIDIA GPU, so as to improve a reasoning speed of the model. The converted model is also saved in the model repository for use in case of deployment.

### III, Algorithm Deployment Table

An Algorithm deployment table can be called as a service deployment table, which is a core file of automatic deployment and testing of the current system. The service deployment table used during algorithm deployment and algorithm testing is a CSV file, in which the columns are: algorithm name, author, algorithm path, model used, test video address, model grouping and jiraID. This service deployment table includes all the information needed to deploy and test AI algorithms. During subsequent automated deployment, the automated deployment script will start all AI algorithms to be deployed according to the information in the service deployment table. The service deployment table is filled out by the service developer, wherein:
Algorithm name field: it can uniquely identify an algorithm, and the test video name is the same as the algorithm name;
Algorithm path field: it can be the above algorithm grouping identifier, and be a path where an entry file of the target algorithm is located. The automatic deployment program will directly run this file to start AI service;
Model grouping field: it can be the above algorithm grouping identifier, and be configured to identify a group of the target algorithm. Algorithm services of the same group and their required algorithm models will run on a same GPU, corresponding to a pod of kubernetes.

The jiraID field is a report address for jira bugs for this service, and if the service fails in the automated test, a log file for this service and failure information are automatically reported to this address.

### IV. Model and Service Grouping

An embodiment of the present disclosure deploys a large-scale standard AI algorithm in a grouping manner. Because there are many models required by services, during large-scale deployment, a single graphics card is insufficient to support all services, the present disclosure groups the deployed services with a GPU graphics card as a unit.

The grouping method may include:
Act 001: taking a group of algorithm models most commonly used for a plurality of target algorithms as a current algorithm model group, and selecting a group of data processing devices as the current data processing devices;
Act 002: adding the current algorithm model group into the current data processing devices;
Act 003: according to available resources of the current data processing devices and resource consumption of all target algorithms corresponding to the current algorithm model group, determining whether the available resources of the current data processing devices can accommodate deploy all the target algorithms corresponding to the current algorithm model group;
adding all the target algorithms corresponding to the current algorithm model group into the current data processing devices when it is determined that the current data processing devices can accommodate and deploy all the target algorithms corresponding to the current algorithm model group; taking a group of algorithm models most commonly used for a plurality of ungrouped target algorithms as the current algorithm model, and proceed to perform act 002;
when it is determined that the current data processing devices cannot accommodate deploy all the target algorithms corresponding to the current algorithm model group, adding target algorithms corresponding to the current algorithm model group which can be accommodated by the current data processing devices into the current data processing devices, adding a new group of data processing devices as the current data processing devices, adding algorithm models in a previous group of data processing devices into the current data processing devices, determining whether there are still ungrouped target algorithms corresponding to the current algorithm models, and if yes, adding the ungrouped target algorithms corresponding to the current algorithm model group into the current data processing devices, otherwise performing act 004; and
Act 004: taking the group of algorithm models most commonly used for the plurality of ungrouped target algorithms as the current algorithm model group, and proceed to act 002.

### V. Automated Deployment Module

In an embodiment of the present disclosure, a trigger of the automated deployment module is an entry script file, and the entry script file can call all deployment program modules in sequence. There are two ways to trigger automated deployment scripts: one is that a deployer logs in to a server and execute them manually, and the other is to use Jenkins to automatically execute them regularly. Jenkins is a continuous integration tool developed based on Java. In an embodiment of the present disclosure, by regularly deploying and testing using Jenkins, bugs are fed back in time and development iteration is accelerated.

As shown in FIG. 2a, the automated deployment module may include:
automatically pulling latest code: pull the latest AI algorithm code in the code repository to ensure that the deployed AI algorithm is consistent with that in a remote code repository.
automatic stream pushing: according to the test video address field in the algorithm deployment table, the test video required by each algorithm is pushed into a real-time video stream for the algorithm to pull.

A method for the automatic stream pushing can include: the test video name corresponding to the target algorithm is the same as the algorithm name, the target algorithms belonging to a same group and the corresponding test video addresses are found, the video is pushed into a video stream using a push stream mirror in the mirror repository, and a pull stream address in a configuration file of the target algorithm is updated as the video stream address.

Automatically generate kubernetes configuration file and start a container: the automated deployment module will write start commands of all AI algorithms in a same group into a kubernetes configuration file according to the algorithm deployment table, and then configure a mount directory and mirror name of the container, etc, according to a kubernetes configuration template. The kubernetes configuration file can be understood as the aforementioned first configuration file, the kubernetes configuration template can be understood as a second configuration file different from the first configuration file, and the second configuration file can be set separately or can be set in the first configuration file.

Starting Triton server: in an embodiment of the present disclosure, the triton server and the AI algorithms are started in a same kubernetes container, and the model managed by the triton server and the AI algorithms belong to the same group. The advantage of this method is that the AI algorithms and model of this group only need one GPU resource to run, and there is no other environmental requirement, so disaster tolerance of this method is very high, and they can be run on any GPU in a kubernetes cluster. After the Kubernetes container starts, it will first start the triton server to load the deep learning model required by AI algorithms of this group.

### Start the Target Algorithm:

After the automated deployment module loads the model, the automated deployment module will start all AI algorithms in the same group, and save output logs of the AI algorithms in a fixed directory for debuggers to view.

Start an automatic test program: the last act of the automated deployment module is to start the automatic test program, the automatic test program will test all the AI algorithms in the same group according to the algorithm deployment table, and automatically report running results of the algorithms.

### VI. Automated Test Module

The automatic test program will test all the AI algorithms in the same group according to the algorithm deployment table, and automatically report the results.

An automatic test method can include: the automatic test program traverses all programs requiring automatic test in the same group according to the algorithm deployment table; if one of algorithm services in the algorithm deployment table belongs to a group required to be checked, a process is started to check all files that should be output by the AI algorithm during the video test; after waiting for 15 minutes, each process will feed back a service test result of which the process is in charge to a parent process; the parent process collects the test information and sends it to a jira test report after summarizing; if there is any service that fails the test, it will separately send the failure result and an algorithm log to a jiraID corresponding to the algorithm service in the algorithm deployment table.

As shown in FIG. 2b, it is a schematic diagram of a logical framework of an automated detection platform in an automatic test module. After completing model development and strategy development, R&D personnel submit an algorithm to a code storage server (which can be understood as the above code repository). An operation and maintenance platform or a test platform periodically triggers an automated detection on algorithms in the code storage server through Jenkins. Contents of the algorithm detection can include configuration detection, compilation detection, model detection, AI platform start state detection and algorithm running state detection. The AI platform in the embodiment of the present disclosure can be understood as the aforementioned target apparatus or a data processing device in the aforementioned target apparatus.

As shown in FIG. 2c, a Jenkins framework can include six configuration modules:

General module: building some basic configurations of a task, discarding old building, and setting a saving strategy of a building history; selectively setting a parameterized building process to configure different parameters, so that the parameters can be used during building.

Source code management module: selecting a GIT (Global Information Tracker) and setting a corresponding GIT parameter. In an exemplary embodiment, setting the GIT parameter may be setting a GIT address that may be an SVN address for accessing the code storage server.

Trigger building module: selecting timed building and setting a corresponding time parameter. Then the trigger building module can trigger a test periodically.

Environment building module: selecting a build tool named as Delete workspace before build starts.

Building module: typically, an environment for the building module is writing execution files. The building module is not set in the embodiments of the present disclosure.

Post-building operation module: realized by designing a calling command and compiling scripts.

According to a period set by the trigger building module and GIT parameters set by the source code management module, algorithm codes are pulled periodically from the GIT address for testing.

An algorithm detection method is described in detail below.

(1) Jenkins automatically pulling git codes: when a test period is reached, triggering periodic automated detection, and the detection platform automatically pulling algorithm codes corresponding to a git address from the code storage repository through Jenkins. Each algorithm code in the code storage server corresponds to a git address, and the detection platform can access the corresponding algorithm code in the code storage server through the git address. In an exemplary embodiment, the code storage server may be referred to as a code storage platform.

In an exemplary embodiment, the operation and maintenance platform acquires the corresponding algorithm code through the git address, and when the algorithms are launched or the algorithms are detected in batches, the operation and maintenance platform can acquire git addresses corresponding to batches of algorithms from the code storage server through jenkins, and acquire a plurality of corresponding algorithm codes according to the git addresses, thereby realizing the algorithm launching or the algorithm detection in batches. In an exemplary implementation, a same git address may correspond to a plurality of algorithms in a batch of algorithms, or each algorithm may correspond to one git address.

(2) Generating a configuration reference file: generating a configuration reference file according to the algorithm codes.

In an exemplary implementation, the configuration reference file may include algorithm names, algorithm model parameters of a plurality of algorithms in the batch of algorithms, path parameters of a database needed for algorithm operation, resource configuration parameters, and video stream information as an algorithm input, wherein the video stream information includes corresponding algorithm names, algorithm strategy information, frame rate threshold and other information. In an exemplary implementation, the configuration reference file may further include information on a person in charge of algorithm research and development and a person in charge of the platform.

In an exemplary implementation, the resource configuration parameters may include occupied CPU, GPU and other resources. For example, an algorithm needs to occupy 100M space of the CPU or GPU and 50M space of the GPU.

(3) Generating configuration file in CSV format based on the configuration reference file.

In an exemplary implementation, in order to meet a format requirement of the detection platform on the configuration file, a configuration file in the CSV format is generated according to the configuration reference file, and the configuration file in the CSV format is taken as a standard in a subsequent detection process.

In an exemplary implementation, the configuration file in the CSV format may include two parts, i.e., a first part and a second part, which are arranged in sequence. The first part may include basic information of a plurality of algorithms, the basic information may include the algorithm name, the algorithm model parameters, and the path parameters of the database needed for algorithm operation above described, and the second part may include algorithm input information that includes the video stream information above described. The basic information of the plurality of algorithms in the first part can be arranged in sequence, and the algorithm input information of the plurality of algorithms in the second part can be arranged in sequence.

(4) CSV generation check: checking whether the configuration file in the CSV format is in a standard format specified by the detection platform, and calling a JIRA interface to feed back a configuration bug of a corresponding algorithm if the configuration file in the CSV format is not in the standard format specified by the detection platform.

In an exemplary implementation, Comma-Separated Values (CSV) are referred to as character-separated values sometimes, because the separator character may not be a comma and its file stores tabular data (numbers and texts) in a plain text form. Plain text means that a file is a sequence of characters without data that must be interpreted like binary numbers. A file in the CSV format includes any quantity of records separated by some kind of line break. Each record is composed by fields, and the separators between the fields are other characters or strings, wherein commas or tabs are the most commonly.

In an exemplary implementation, CSV checking may include checking whether the configuration file in the CSV format meets the format requirement of the standard configuration file. For example, the format of the standard configuration file refers to that records are separated by commas, and if it is checked that records are separated by semicolons in the configuration file in the CSV format, an abnormality occurs in CSV generation.

(5) Configuration check, which may include checking whether the algorithm name in the basic information of the configuration file is consistent with the algorithm name in the algorithm input information, and if the algorithm name in the basic information of the configuration file is not consistent with the algorithm name in the algorithm input information, the JIRA interface is called to feed back the configuration bug of the corresponding algorithm.

In an exemplary implementation, if some algorithms do not need an input video stream, null input video stream information can be marked in the algorithm name of the basic information. When the null input video stream information marked in the algorithm name is detected, it can be determined that no abnormality occurs according to the marking, and the JIRA interface may not to be called to feed back the bug of the corresponding algorithm.

In an exemplary implementation, even many algorithms do not take video stream information as an input in an actual running process, the video stream information is configured in model development and strategy development processes, while corresponding video stream resources are not used in the running process. In this case, if video stream information corresponding to an algorithm name is not detected in a configuration checking process, the JIRA interface can be called to feed back a bug of a corresponding algorithm.

In an exemplary implementation, a bug is a general designation for software, programs, codes, algorithms, vulnerabilities, flaws, bug issues in a computer system.

(6) Compile code: Jenkins compiles the algorithm code by calling a compilation interface according to a compiler instruction.

In an exemplary implementation, Jenkins acquires a compilation instruction of the corresponding algorithm according to the git address, and automatically calls the compilation interface to compile the algorithm code, which can reduce manual deployment of a compilation environment and a manual compilation process, thereby reducing labor costs and improving the efficiency.

(7) Compilation check, which can include: checking whether an algorithm compilation process reports an error and checking whether an algorithm compilation result is successful; if the compilation process reports an error or the compilation result is unsuccessful, calling the JIRA interface to feed back a compilation bug of the corresponding algorithm. In an exemplary implementation, checking whether the algorithm compilation process reports the error and checking whether the algorithm compilation result is successful may include acquiring a log compiled by Jenkins and checking whether an error exists in the compilation log. For example, whether information such as “error” exists in the compilation log is checked.

(8) Model check, which can include: according to the configuration file, checking whether the model file needed by the launched algorithm is prepared correctly; and calling the JIRA interface to feed back a model bug of the corresponding algorithm if it is detected that the model file is not prepared correctly.

In an exemplary implementation, checking whether the model file needed by the launched algorithm is prepared correctly may include: searching for whether a model file corresponding to the algorithm exists according to the model parameter in the configuration file.

In an exemplary implementation, once an abnormality occurs in a process of the CSV generation check, the configuration check and the model check, the JIRA interface service is called to automatically submit a corresponding bug to a JIRA server, and the JIRA server displays the corresponding bug to a user through a browser, and a corresponding developer can view the corresponding bug through a corresponding browser.

In a process of manual launch, when a bug occurs in the operation and maintenance or the test, an operation and maintenance person or a testing person usually communicates with a developer, and the operation and maintenance person or the testing person does not fully understand the bug in a development process, which results in a high communication cost. In an embodiment of the present disclosure, bug information is uploaded to the JIRA server through the JIRA interface, and the developer, the person in charge of the platform, the testing person or the operation and maintenance person can view the corresponding bug information by logging in a JIRA account, thus reducing the communication cost to a great extent. In an exemplary implementation, Jenkins is an open source, user-friendly Continuous Integration (CI) tool for continuous, automated build/test software projects and monitoring an operation of an external task.

(8) Check a running status of the AI platform.

In an embodiment of the present disclosure, the AI platform can be understood as a cloud platform or other platform with AI algorithms deployed.

As shown in FIG. 3, checking the running status of the AI platform may include the following acts 11 to 13.

In the act 11, an AI platform is started and the act 12 is performed after waiting for a first preset period.

In an exemplary embodiment, the first preset period may last for 1 minute to 5 minutes. For example, the first preset period may be 3 minutes.

In an exemplary implementation, the AI platform can be started after the code is compiled, check of the running status of the AI platform can be started after the compile check and the model check are performed, check of the running status of the AI platform is started and the act 12 is performed after waiting for a first preset period.

In the act 12, existence of the AI platform service is checked. If the AI platform service exists, the check is finished, otherwise the act 13 is executed.

In an exemplary implementation, existence of the AI platform service is checked to determine whether a process of the AI platform is started, the act 13 is performed if the process is not started, otherwise the check is finished.

In the act 13, the JIRA interface is linked to submit the bug.

In the act 13, the AI platform start abnormality is submitted to the JIRA server through the JIRA interface, and a user (a person in charge of the AI platform or a developer) can log in to the JIRA server to view the corresponding bug and solve a corresponding problem. In an embodiment of the present disclosure, the JIRA server can serve as the above-mentioned abnormal information feedback platform.

(9) Check a running status of the algorithm.

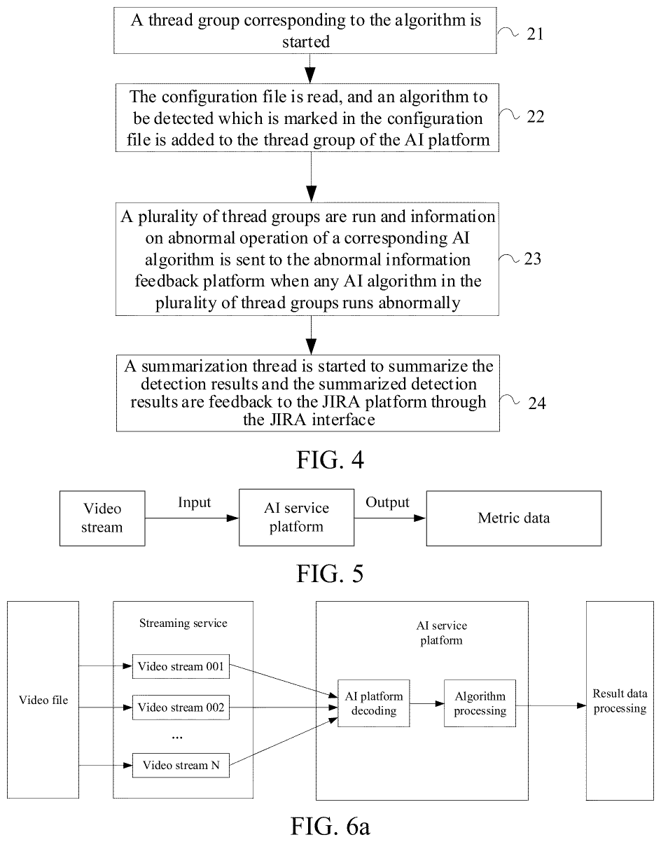

As shown in FIG. 4, checking the running status of the AI algorithm may include the following acts 21 to 24.

In the act 21, a thread group corresponding to the algorithm is started.

In an exemplary implementation, an operation of starting the algorithm can be performed after a process in the AI platform is started.

In an exemplary implementation, starting the algorithm includes starting threads corresponding to the quantity of algorithms after an AI platform process is started. When a plurality of algorithms are started, each algorithm corresponds to one thread, and a thread group including a plurality of threads is started in the process.

In the act 22, the configuration file is read, and an algorithm to be detected which is marked in the configuration file is added to the thread group of the AI platform.

In an exemplary implementation, in a process of algorithm testing or algorithm launching in batches, only a part of the algorithms can be added to a current thread group due to limited resources of the thread group, and remaining algorithms can be added to other thread groups or tested in a next test. In an exemplary implementation, all algorithms recorded in the configuration file may be detected by default without setting an identifier as to whether the detection is needed.

In an exemplary implementation, each algorithm is loaded into one of the threads in the thread group.

In the act 23, a plurality of thread groups are run and information on running abnormality of a corresponding AI algorithm is sent to the abnormal information feedback platform when abnormality occurs in running of any AI algorithm in the plurality of thread groups.

In an exemplary implementation, when abnormality of an algorithm is detected, the JIRA interface is linked, a bug is submitted and fed back to a JIRA service platform (i.e., the abnormal information feedback platform), and a person in charge of the algorithm can log in to the JIRA sever, view a JIRA bug and process corresponding algorithm abnormality.

In an exemplary implementation, an output result of the algorithm can be obtained when no abnormality occurs in a detection result after execution of the algorithm detection.

In the act 24, a summarization thread is started to summarize the detection results and the summarized detection results are feedback to the JIRA platform through the JIRA interface.

In an exemplary implementation, the configuration file may include a mailbox address of a person in charge of research and development or a person in charge of the AI platform. After the JIRA platform receives the corresponding bug, corresponding bug information can be sent to the corresponding person in charge of research and development or the person in charge of AI platform according to the mailbox address.

In an exemplary implementation, the summarization thread feeds back a summary detection result to the JIRA server through the JIRA interface, and the person in charge of the AI platform logs in to the JIRA server to acquire a detection result, and determines whether a launch result of the algorithm meets an expectation according to the detection result. In an exemplary implementation, the summary detection result may include a total quantity of codes of the detected algorithms, a quantity of successful algorithm tests, a quantity of failed algorithm tests, a success list, and a failure list.

In an exemplary implementation, if there is a bug in an algorithm detection process performed by the threads, the test is considered as an unsuccessful test, and corresponding bug information is uploaded to the JIRA platform through the JIRA interface.

In an exemplary implementation, the success list contains a list of algorithms with successful algorithm tests, and the failure list contains a list of algorithms with failed algorithm tests.

In an exemplary embodiment, the person in charge of the AI platform confirms whether the launch result of the algorithm meets the expectation according to the detection result, and can make a determination according to a type of the algorithm with a detection failure or success, for example, there are a total of 21 algorithms tested in batch. If there is an abnormality in one algorithm test, the platform person in charge the platform evaluates that it is not a must to launch the abnormal algorithm this time, then only 20 successful algorithms can be launched, and this algorithm test meets the expectation; if there are 21 detected algorithms in total, and 10 algorithms that must be launched are detected with abnormalities, they can't meet the expectations and can't be launched, and the corresponding person in charge of research and development need to solve the corresponding bugs and then retest, that is, repeat the detection process from (1) to (9) above until the test expectations are met.

In an exemplary implementation, the detection result is submitted to the JIRA platform server automatically, achieving a streamline function without a manual operation, thereby saving labor costs.

In an exemplary implementation, the detection result may include a detection log and an abnormality record, and the detection log may include a detection time as well as the success list and the failure list described above. For example, the detection log is as follows:
2021 Oct. 18 16:10:25 [model_repository2] auto test end! total: 16 failed: 7
FAILED LIST: [‘highway_lowspeed’, ‘drive_without_license’, ‘drive_license_without_permission’, ‘drive_inout’, ‘driver_car_match’, ‘station_leave’, ‘wandering_alarm’]
NEW JIRA LIST: [ ]
YF2021430-131.

Detection end time recorded in the above-mentioned detection log is 16:10:25 on Oct. 18, 2021, with a total detection quantity of 16 and a failure quantity of 7. Algorithms which are detected as fail algorithms in the failure list include: ‘highwayjowspeed’, ‘drive_withoutjicense’, ‘drive_license_without permission’, ‘drivejncut’, ‘driver_car_match’, ‘stationjeave’ and ‘wandering_alarm’

A summary of the abnormality log includes:
[AI300OnlineCheck: C-Video] [check. CorfigCheckLog] ERRORBUG exists in vehiclebreakin
[AI300OnlineCheck: C-Video] [CHECK_CompleckLog] ERRORBUG exists in Non VehiclelllegalParkingDetect
[A1300OnlineCheck: C-Video] [check_CorfigCheckLog] ERRORBUG exists in vehiclebreakin

In an exemplary implementation, Jenkins can integrate with automatic launch detection which is set to run regularly, so as to improve a detection efficiency. For example, an automatic launch detection service can be run periodically at 11:30 a.m. and 16:30 p.m. on Jenkins every working day, which is convenient for launching the algorithms intensively in the morning or afternoon.

In an embodiment of the present disclosure, the algorithm runs on the AI platform to provide a message interface for services, and one or more cameras may need to access an actual service scenario. If platform resources are insufficient, video stream processing failure, service crash and other problems may occur. In order to avoid the video stream processing failure, the service crash and other problems caused by insufficient platform resources after accessing, after no abnormal occurs during the algorithm detection and the algorithm is launched successfully and before the plurality of cameras access, algorithm metrics can be tested when the plurality of cameras access the AI platform. In an exemplary implementation, when the plurality of cameras access AI platform under a single card/single machine configuration, the algorithm metrics can be tested, so as to acquire a graph of algorithm metric value versus the quantity of cameras in an existing service configuration of the platform, which has data significance for advance planning and design of product commercialization and resource configuration. In an embodiment of the present disclosure, the single card can refer to a Graphics Processing Unit (GPU), which is also referred to as a display core, a visual processor or a display chip, and the single machine can be a physical machine configured with a plurality of GPU cards.

In an embodiment of the present disclosure, logic of the algorithm metric test is shown in FIG. 5, and a video stream, an AI platform service and metric item data are described below.

Video stream: an input source of the AI platform service. Multiple video streams can be simulated by video files, or by converting one video stream to multiple video streams.

In an exemplary implementation, one video file can be copied into N video files, and the N video files are converted to form N video streams respectively. Or, one video file is converted to form a video stream, and the video stream is copied to form N video streams.

AI platform service: algorithm service based on AI platform framework, Input of the AI platform service is one or more video streams, and output of the AI platform service is a frame rate, a quantity of messages processed, a message file, system resource occupancy (such as a CPU occupancy rate/a GPU occupancy rate), etc. The AI platform service includes video stream decoding, algorithm processing, metric data item recording, outputting and other functions.

Metric item data: metric item output required by the AI platform service when processing N video streams. Taking a perimeter intrusion algorithm as an example, it is needed that its output should include a quantity of alarm messages, an average processed frames per second (in fps), pixel positions of an alarm picture detection box, and a system resource occupancy rate (CPU/GPU).

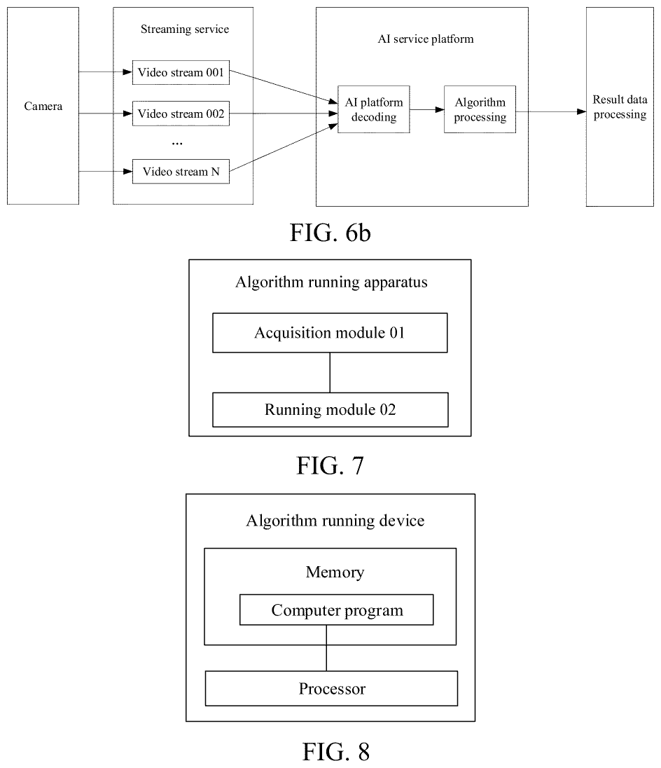

In an exemplary implementation, as shown in FIGS. 6a and 6b, schematic diagrams of logical frameworks of two kinds of video source processing are shown, a video file is taken as a video source, as shown in FIG. 6a.

Streaming media service: providing a video file converting service. A video file can be converted into N video streams specified for requirements. The converted video stream is served as the video stream input of AI platform service.

AI platform service: the service provided for the AI service platform shown in FIG. 5. Refer to the description of the AI service platform mentioned above for specific services, which will not be repeated here.

Results Data processing: for the output of AI platform services, data processing is carried out to obtain corresponding metric diagram.

As shown in FIG. 6b, a real camera is used as a video source input.

Streaming media service: providing a converting service. A video stream of a camera can be converted into N video streams specified for requirements. The converted video stream is used as the video stream input of the AI platform service.

AI platform service: the service provided for the AI service platform shown in FIG. 5. Refer to the description of the AI service platform mentioned above for specific services, which will not be repeated here.

Results Data processing: for the output of AI platform services, data processing is carried out to obtain the corresponding metrics diagram.

In an exemplary implementation, a metric relationship diagram obtained from the above may include a graph of accuracy versus quantity of cameras.

In an embodiment of the present disclosure, the result data processing described in FIGS. 6a and 6b can employ a form described in the act S2, and the result data processing finally obtains test results of the algorithm metrics.

In an embodiment of the present disclosure, the video stream can be generated in a simulation manner, which has the following advantages compared with the video stream of a real camera:
(1) It can ensure that the input sources are consistent, and an obtained metric conclusion is comparable.
(2) It can ensure that a density of a single frame picture meets specific requirements, for example, a quantity of people in a single frame picture needs to reach 30, and a metric value of a capacity test can be obtained. However, it is difficult for a real camera to ensure the density of a single frame picture.
(3) It is easy to expand and construct. According to an actual requirement, the metric values for N videos stream (such as 8, 16, 32 and 100 video streams) can be compared.

Based on the above three advantages, comparing with the case of numerous videos streams, fast implementation is difficult when use a real camera regarding the quantity of cameras, purchase, construction and simulation of crowd density of a picture.

In an exemplary implementation, in two video stream simulation methods in FIGS. 6a and 6b, a video stream obtained by a video file is employed in FIG. 6a, compared with a video stream obtained by using real camera simulation in FIG. 6b, a scenario video satisfying the density of the single frame picture can be conveniently customized.

An embodiment of the present disclosure further provides an algorithm running apparatus, as shown in FIG. 7, which can include an acquisition module 01 and an operation module 02.

Acquisition Module 01, which may be configured to acquire grouping information of a plurality of groups of target algorithms;

Running Module 02, which may be configured to run the plurality of groups of target algorithms on a plurality of data processing devices according to the grouping information of the plurality of groups of target algorithms; wherein target algorithms corresponding to a same group of grouping information are run on a same data processing device.

An embodiment of the present disclosure further provides an algorithm running device, as shown in FIG. 8, which may include a memory, a processor, and a computer program stored on the memory and runnable on the processor, to perform following operations:
acquiring grouping information of a plurality of groups of target algorithms;
running the plurality of groups of target algorithms on a plurality of data processing devices according to the grouping information of the plurality of groups of target algorithms; wherein target algorithms corresponding to a same group of grouping information are run on a same data processing device.

An embodiment of the present disclosure further provides a non-transitory computer-readable storage medium, configured to store computer program instructions, wherein when the computer program instructions are executed, the algorithm running method according to any one of the above embodiments can be implemented.

The embodiments of the present disclosure provide an algorithm, an apparatus, and a device for running a method and a storage medium. In the algorithm running method, the plurality of groups of target algorithms are run on a plurality of data processing devices according to the grouping information of the plurality of groups of target algorithms, and the target algorithms corresponding to a same group of grouping information are run on a same data processing device. The method provided by the embodiment of the disclosure can overcome the problems of high source occupation during algorithm deployment and running, thereby enabling AI algorithms to have high engineering efficiency and low cost.

Those of ordinary skills in the art may understand that all or some of acts in the methods disclosed above, systems, functional modules or units in apparatuses may be implemented as software, firmware, hardware, and an appropriate combination thereof. In a hardware implementation, division of the function modules/units mentioned in the above description is not always corresponding to division of physical components. For example, a physical component may have multiple functions, or a function or an act may be executed by several physical components in cooperation. Some components or all components may be implemented as software executed by a processor such as a digital signal processor or a microprocessor, or implemented as hardware, or implemented as an integrated circuit such as a specific integrated circuit. Such software may be distributed on a computer-readable medium, and the computer-readable medium may include a computer storage medium (or a non-transitory medium) and a communication medium (or a transitory medium). As known to those of ordinary skills in the art, a term computer storage medium includes volatile or nonvolatile, and removable or irremovable media implemented in any method or technology for storing information (for example, a computer-readable instruction, a data structure, a program module, or other data). The computer storage medium includes, but is not limited to, an RAM, an ROM, an EEPROM, a flash memory or another memory technology, a CD-ROM, a Digital Versatile Disk (DVD) or another optical disk storage, a magnetic cartridge, a magnetic tape, magnetic disk storage or another magnetic storage apparatus, or any other medium that may be configured to store desired information and may be accessed by a computer. In addition, it is known to those of ordinary skill in the art that the communication medium usually includes a computer-readable instruction, a data structure, a program module, or other data in a modulated data signal of, such as, a carrier or another transmission mechanism, and may include any information delivery medium.

The drawings of the embodiments of the present disclosure only involve structures involved in the embodiments of the present disclosure, and other structures may refer to a general design.

The embodiments of the present disclosure, i.e., features in the embodiments, may be combined with each other to obtain new embodiments if there is no conflict.

Although implementations disclosed in the present disclosure are described as above, the described contents are only implementations which are used for facilitating understanding of the present disclosure, but are not intended to limit the present disclosure. Any of those skilled in the art of the present disclosure can make any modifications and variations in the implementation and details without departing from the essence and scope of the present disclosure. However, the protection scope of the present disclosure should be subject to the scope defined by the appended claims.

1. An algorithm running method, comprising:
acquiring grouping information of a plurality of groups of target algorithms;
running a plurality of groups of target algorithms on a plurality of data processing devices according to the grouping information of the plurality of groups of target algorithms; wherein target algorithms corresponding to a same group of grouping information are run on a same data processing device.

2. The algorithm running method according to claim 1, wherein any group of the grouping information comprises at least one piece of target algorithm information and algorithm model information corresponding to the at least one piece of target algorithm information.

3. The algorithm running method according to claim 1, wherein before acquiring the grouping information of the plurality of groups of target algorithms, the method further comprises:
acquiring available resources of the plurality of data processing devices and resource consumption required for deploying any one of the target algorithms; and
grouping the plurality of target algorithms in units of the data processing devices according to the available resources and the resource consumption; a same target algorithm and an algorithm model corresponding to the algorithm being divided into a same group of data processing devices, wherein the same group of data processing devices corresponds to at least one target algorithm and an algorithm model corresponding to the at least one target algorithm.

4. The algorithm running method according to claim 3, wherein grouping the plurality of target algorithms in units of the data processing devices according to the available resources and the resource consumption comprises:
taking a group of algorithm models most commonly used for the plurality of target algorithms as a current algorithm model group, and selecting a group of data processing devices as the current data processing devices;
adding the current algorithm model group into the current data processing devices;
determining whether available resources of the current data processing devices can accommodate and deploy all target algorithms corresponding to the current algorithm model group according to the available resources of the current data processing devices and resource consumption for deploying all the target algorithms corresponding to the current algorithm model group; and
adding all the target algorithms corresponding to the current algorithm model group into the current data processing devices when it is determined that the current data processing devices can accommodate and deploy all the target algorithms corresponding to the current algorithm model group; taking a group of algorithm models most commonly used for a plurality of ungrouped target algorithms as the current algorithm model group, and then adding the current algorithm model group into the current data processing devices.

5. The algorithm running method according to claim 4, wherein when it is determined that the current data processing devices cannot accommodate and deploy all the target algorithms corresponding to the current algorithm model group, the method further comprises:
adding target algorithms corresponding to the current algorithm model group which can be accommodated by the current data processing devices into the current data processing devices, adding a new group of data processing devices as the current data processing devices, adding algorithm models in a previous group of data processing devices into the current data processing devices, and adding the ungrouped target algorithms corresponding to the current algorithm model group into the current data processing devices; taking the group of algorithm models most commonly used for the plurality of ungrouped target algorithms as the current algorithm model group, and then adding the current algorithm model group into the current data processing devices.

6. The algorithm running method according to claim 1, wherein acquiring the grouping information of the plurality of groups of target algorithms comprises: acquiring an algorithm deployment table including the grouping information of the plurality of groups of target algorithms and resource configuration information of the target algorithms, the grouping information including a plurality of algorithm grouping identifiers;
running the plurality of groups of target algorithms on the plurality of data processing devices according to the grouping information of the plurality of groups of target algorithms comprises:
generating a plurality of first configuration files according to the plurality of algorithm grouping identifiers, writing start commands of all target algorithms corresponding to a same algorithm grouping identifier into a first configuration file corresponding to the algorithm grouping identifier;
configuring a data processing device for the plurality of first configuration files respectively according to resource configuration information of a plurality of groups of target algorithms corresponding to the first configuration files;
starting micro service containers in corresponding data processing devices according to the first configuration files, and starting model managers in the micro service containers;
controlling the model managers to load the algorithm models corresponding to the group of target algorithms; and
running corresponding target algorithms in corresponding micro service containers; wherein algorithms and model managers corresponding to a same algorithm grouping identifier are started in a same data processing device.

7. The algorithm running method according to claim 6, wherein after running the corresponding target algorithms in the corresponding micro service containers, the method further comprises outputting and saving running results of the algorithms.

8. The algorithm running method according to claim 6, wherein running the corresponding target algorithms in the corresponding micro service containers comprises running the corresponding target algorithms in the corresponding micro service containers and calling algorithm models required by the target algorithms.

9. The algorithm running method according to claim 6, wherein the algorithm deployment table further comprises algorithm code addresses and algorithm running paths;
before starting the corresponding target algorithms in the corresponding micro service containers, the method further comprises: acquiring codes of the target algorithms according to the algorithm code addresses; and
starting the corresponding target algorithms in the corresponding micro service containers comprises: running codes of the corresponding target algorithms in the corresponding micro servers according to the algorithm running paths.

10. The algorithm running method according to claim 6, wherein the algorithm deployment table further comprises a test video stream address, an algorithm name and a feedback test output address;
after acquiring the algorithm deployment table, the method further comprises: acquiring a video source file according to the test video stream address, pushing the video source file used for testing the target algorithms into a video stream using a preset push stream mirror, generating a pull stream address, and updating a first configuration file corresponding to the target algorithms by using the pull stream address; wherein the video stream address and the pull stream address include a video name, and the video name has a corresponding relationship with a corresponding algorithm name;
after running the corresponding target algorithms in the corresponding micro service containers, the method further comprises: traversing the target algorithms of the video stream to be tested according to the algorithm deployment table, starting a test platform, starting the target algorithms of the video stream to be tested for playing test according to the corresponding video stream address, waiting for a preset time, collecting test reports fed back by a plurality of target algorithms, and sending information on failure in passing the test to an abnormal information feedback platform through the feedback test output address.

11. The algorithm running method according to claim 6, wherein the algorithm deployment table further comprises algorithm model information;
before acquiring the grouping information of the plurality of groups of target algorithms, the method further comprises: converting original algorithm models in a model repository into open neural network exchange format, converting the open neural network exchange formats to obtain TensorRT models, and saving the TensorRT models into the model repository; merging a part of network layers in the original algorithm models in a process of converting into the TensorRT models;
controlling the model managers to load the algorithm models corresponding to the group of target algorithms comprises: acquiring the algorithm model information corresponding to the target algorithms, and controlling the model managers to load TensorRT models corresponding to the algorithm model information from the model repository.

12. The algorithm running method according to claim 6, wherein after running the corresponding target algorithms in the corresponding micro service containers, the method further comprises:
testing all the target algorithms according to the service deployment table, and outputting and saving test results.

13. The algorithm running method according to claim 1, wherein before acquiring grouping information of the plurality of groups of target algorithms, the method further comprises: triggering periodic deployment; and
after running the plurality of groups of target algorithms on the plurality of data processing devices according to the grouping information of the plurality of groups of target algorithms, the method further comprises triggering periodic detection.

14. An algorithm running apparatus, comprising an acquisition module and a running module; wherein
the acquisition module is configured to acquire grouping information of a plurality of groups of target algorithms;
the running module is configured to run the plurality of groups of target algorithms on a plurality of data processing devices according to the grouping information of the plurality of groups of target algorithms; wherein target algorithms corresponding to a same group of grouping information are run on a same data processing device.

15. An algorithm running device, comprising a memory, a processor, and a computer program stored on the memory and runnable on the processor, to perform:
acquiring grouping information of a plurality of groups of target algorithms;
running the plurality of groups of target algorithms on a plurality of data processing devices according to the grouping information of the plurality of groups of target algorithms; wherein target algorithms corresponding to a same group of grouping information are run on a same data processing device.

16. A non-transitory computer-readable storage medium, configured to store computer program instructions, wherein when the computer program instructions are executed, the algorithm running method according to claim 1 is implemented.
